(19) United States
(12) Patent Application Publication
(10) Pub. No.: US 2004/0080129 A1
(43) Pub. Date: Apr. 29, 2004

(54) Shopping cart list & writing tablet accessory device

(76) Inventors: Norman E. Myers, Tucson, AZ (US); Dennis Brizee, Tucson, AZ (US)

Correspondence Address: Dennis Brizee, 2054 South La Costa Drive, Tucson, AZ, 85710, US

(21) Appl. No.: 10/282,298

(22) Filed: Oct. 29, 2002

(51) Int. Cl. B62D 39/00

(52) U.S. Cl. 280/33.992

(57) ABSTRACT

A small writing tablet device which can be installed as an accessory device for new shopping carts from a manufacturer or can be added to existing shopping carts at the various markets and stores without any difficulty.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The design purpose and concept objective of this patent is to provide a system device that will allow the owners of businesses that use grocery store type shopping carts to have access to an accessory note writing platform device. This device will allow these businesses to provide their purchasers with a small platform attached onto the wire basket and the push bar handle of these type cart units.

Manufacturers of these grocery store type shopping carts will also be able to offer this device as either an accessory or a standard element for the various grocery store types of wire basket carts that they manufacture.

The design of this invention will allow these units to become accessory items for existing carts and as such new carts can be sold as either an included accessory item or as an optional purchase item.

A major advantage of this type writing platform device is that it provides a slight slope that also has a reinforcing edge around the perimeter of the three outside edges of the sloped platform. The reinforcing edge along the lower edge of the platform is folded back to allow papers, identification cards and other similar elements to be placed on the platform. This fold-back edge is designed to be thick enough to accept a pen or pencil to lay against this edge without falling off under normal usage.

### BRIEF SUMMARY OF THE INVENTION

This invention will allow one to utilize an inexpensive and simple device when doing their grocery shopping and securing items from a purchase list developed prior to entering a store. They will have a small, but normally adequate writing platform to simply check-off the list and can also add notes to review a future listing to consider for their next future purchase. The width of this platform is also wide enough to allow two lists and then the child can participate in the occasion by having their own list and crossing off their items as they are secured.

This system will allow the end user of this product to simply and easily insert a list on the top of the writing platform and then lay a pencil on top of this list. They can then go about their business of selecting from the list until all needed items are crossed off the list of items to be purchased on the top of this writing area.

The invention will not interfere with the use of the child's seat that is now considered almost a general requirement for a grocery store type shopping cart. This writing platform device can remain on the cart and will not interfere with either the child or in the stacking of the normal cart units where they interleaf with each other when lined up either outside or inside the entrance to a store. This thereby will allow the storeowners who purchase these type carts to provide these on their existing carts they now have or on new carts they intend to purchase, as an accommodation not normally provided for customers in any other manner. This item possibly could also be available to purchasers as an optional extra item.

This device does not require any operational conditions other than the installation of this writing platforms onto the metal (or plastic in some cases) framework of the basket frame portion of these cart units. These are attached to this framework in a manner similar to the usual method of installing the child's hinged seat now available on almost all of these types of shopping carts with the unit having a friction clamping type device.

### BRIEF DESCRIPTION OF THE SEVERAL VIEWS OF THE DRAWING

The intention of all drawings for this invention is to show these drawings as depicting this invention in a market ready configuration and in an applied condition, unless showing an individual element of a part or of a system individually.

Drawing Sheet 1 shows a side elevation outline view of a normal shopping cart unit with the List and Writing Accessory Device shown and highlighted in a dashed oval.

Drawing Sheet 2, shows a sectional view of the tablet unit attached to the shopping cart unit. The diagonally hatched items are the existing mounting portions of the normal grocery cart and are defined as Item 30 the top portion of the cart basket and Item 16 the push bar handle on a normal shopping cart.

Drawing Sheet 3, shows a top plan view of a normal shopping cart with the List and Writing Tablet accessory device shown on the rear of the normal shopping cart and marked as item 30 in a dashed oval.

Drawing Sheet 4, Indicates an elevation/section of the List and Writing Tablet accessory device shown on the rear of the normal shopping cart and marked as item 18.

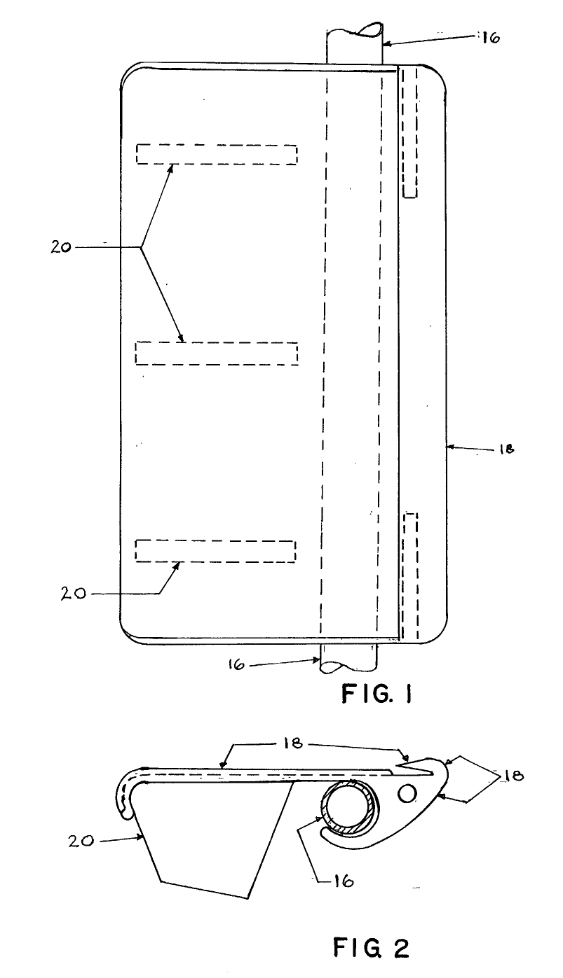

Drawing Sheet 5, FIG. 1, shows a top plan view of the tablet unit assembly with the three front resting legs on the bottom side of the tablet shown in dashed lines and the two pencil holes also shown with dashed lines on each side of the tablet unit.

Drawing Sheet 5, FIG. 2, shows a side sectional elevation view of the tablet unit.

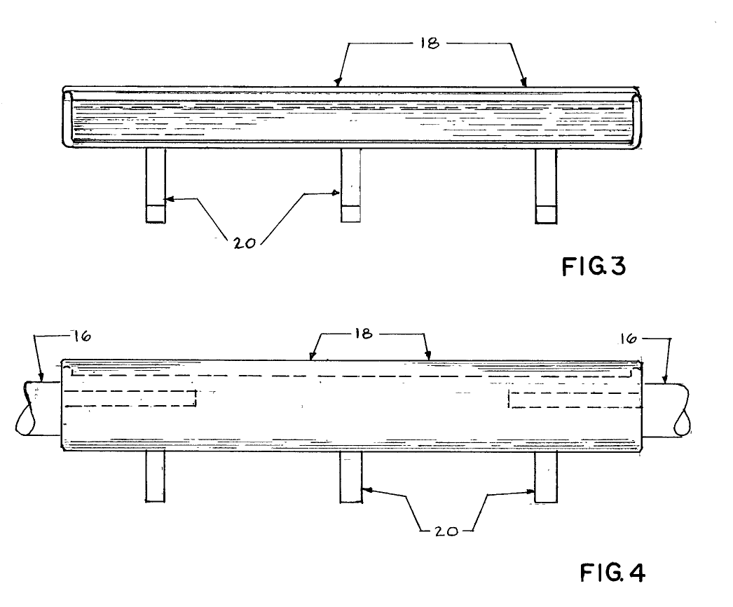

Drawing Sheet 6, FIG. 3, shows a front elevation looking from the cart basket side towards the tablet unit with its curved front side which acts as a protective element for the child when they would be sitting in the normal folding seat in a standard grocery cart unit The three front resting legs are shown dotted on the bottom side of this elevation.

Drawing Sheet 6, FIG. 4 shows the rear elevation looking from the rear, shopping cart pushing side of the tablet unit and indicates the tubing push edge of the shopping cart to which this tablet unit is attached. The three front resting legs are shown dotted on the bottom side of this elevation. The two pencil holes at each side of the tablet unit are shown in dashed lines. The top writing surface is also shown in a dashed line across the entire width of the elevation of the tablet unit.

### DETAIL DESCRIPTION OF THE INVENTION

Although various elements and embodiments of this present invention are illustrated and described herein, they are not intended to be limiting within the context of their conceptual operation and the resultant performance of this invention. Those with skill in this art will be able to recognize various modifications and further embodiments of this invention, which are intended to be included by the scope and spirit of the concept of this device.

Drawing Sheet 1 indicates an outline sketch of a standard grocery type shopping cart unit including wheel units, carriage unit shown in the heavier tubing and an outline of the heavy wire rod basket structure for the transportation on ones basic and incidental shopping items. Not shown on this illustration is the Tablet Writing Device which is shown on Drawing Sheet 2.

Drawing Sheet 2 indicates the above sheet 1 outline drawing with the addition of the List and Writing Accessory Device which is shown and highlighted within a dashed line oval and marked as reference item number 30.

Drawing Sheet 3 indicates a plan view outline sketch of a standard grocery type shopping cart unit where the List and Writing Accessory Device is shown and highlighted within a dashed line oval and marked as reference item number 30.

Drawing Sheet 4 indicates a sectional drawing sketch of the List and Writing Accessory Device indicating its attachment to a normal shopping cart where the devices front three legs rest on the resting rod 14 of the carts basket unit. The solid attachment is made where a snap-on friction type connection is made to the shopping carts pushing bar 16 unit and mounted at the center of the shopping cart.

Drawing Sheet 5, FIG. 1 indicates a basic plan view of the List and Writing Accessory Device with its top surface outlined and the three resting legs 20 shown in dashed lines. The bottom of the fastening element that has a snap-on connection to a shopping cart push bar 16 is shown in a dashed line.

Drawing Sheet 5, FIG. 2 indicates an elevation view of the List and Writing Accessory Device with the push bar unit 16 of the shopping cart shown hatched as also the top rear resting rod rail 14 of the shopping cart basket is shown hatched.

Drawing Sheet 6, FIG. 3 indicates a frontal view of the List and Writing Accessory Device viewed from the front of the shopping cart assembly. The three front resting legs 20 of the List and Writing Accessory Device are the three units at the bottom of this elevation. The hatched line across the width of the tablet indicates the bottom surface of this tablet unit.

Drawing Sheet 6, FIG. 4 indicates a rear view of the List and Writing Accessory Device viewed from the rear, pushing side, of the shopping cart assembly. The upper hatched line across the width of the tablet unit indicates the top surface of the List and Writing Accessory Device beyond the raised lip edge that will hold down papers at this end of the tablet surface.

1. Our only claim is this simple device can and should serve as an adequate surface in which to place a normal shopping list. It also has the writing surface to scratch out the items purchased, add new items and can also serve as a writing surface to make out the basic start of a check while waiting to be served at a cash register location.
